(19) United States
(12) Patent Application Publication
(10) Pub. No.: US 2020/0298758 A1
(43) Pub. Date: Sep. 24, 2020

(54) SYSTEM AND METHOD OF ANIMAL DETECTION AND WARNING DURING VEHICLE START UP

(71) Applicant: GM GLOBAL TECHNOLOGY OPERATIONS LLC, Detroit, MI (US)

(72) Inventors: Shridhar Janaba Ardalkar, Bengaluru (IN); Praveen M. Naik, Bangalore (IN); Pravinkumar S. Nalawade, Bangalore (IN)

(21) Appl. No.: 16/356,190

(22) Filed: Mar. 18, 2019

(51) Int. Cl. B60R 1/00; A01M 29/18; A01M 29/16; A01M 29/00; B60Q 5/00; B60T 7/22

(52) U.S. Cl. CPC B60R 1/002; A01M 29/18; B60T 7/22; A01M 29/00; B60Q 5/005; A01M 29/16

(57) ABSTRACT

One general aspect includes a method of animal detection and warning, the method including: detecting, via a processor, a presence of an animal in an area beneath a vehicle; and when the presence of an animal is detected in the area beneath the vehicle, warning, via the processor, the animal to vacate the area beneath the vehicle. Other embodiments of this aspect include corresponding computer systems, apparatus, and computer programs recorded on one or more computer storage devices, each configured to perform the actions of the methods.

### INTRODUCTION

People and small animals coexist in modern day life. That said, animals often use manmade objects to their own benefit. For example, especially when it is cold or raining outside, cats like to hide out underneath automobiles to seek shelter from forbidding elements. However, with these benefits can come the risk of harm. Using the above example, if the vehicle's owner happens to come back to their vehicle, they may drive off and accidentally squash the cat with one of the tires. As follows, some sort of vehicle-installed safety precaution would have saved this cat's life. Moreover, small children like playing games that involve hiding from other children or adults. These kids can, for example, find themselves hiding under automobiles to sneak away from the other participants of their games. However, this hiding spot also runs the risk of the vehicle's owner returning, driving off, and accidentally hitting the child with their tire (especially if the child gets trapped under the vehicle and can't get out upon hearing the engine being activated). Furthermore, people often make vehicle maintenance one of their hobbies. They generally like to fix minor problems with their own vehicles and the vehicles of friends, neighbors, and family members. Such repairs often entail someone sliding under a vehicle to work on its undercarriage. However, working under a vehicle runs the risk of the vehicle's owner returning, driving off, and accidentally hitting the amateur mechanic with one or two of their tires (especially if this service person gets trapped under the vehicle and can't get out upon hearing the engine being activated). Accordingly, it is desirable to provide a system and method that will detect an animal such as a cat, dog, child, or mechanic under a vehicle as well as take proactive measures to help remove the animal from this location. It is also desirable for this system and method to automatically begin its operations just after the vehicle ignition is turned on. Moreover, other desirable features and characteristics of the present invention will become apparent from the subsequent detailed description of the invention and the appended claims, taken in conjunction with the accompanying drawings and this background of the invention.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method of animal detection and warning, the method including: detecting, via a processor, a presence of an animal in an area beneath a vehicle; and when the presence of an animal is detected in the area beneath the vehicle, notifying, via the processor, a vehicle occupant that the presence of an animal has been detected in the area beneath the vehicle. Other embodiments of this aspect include corresponding computer systems, apparatus, and computer programs recorded on one or more computer storage devices, each configured to perform the actions of the methods.

Implementations may include one or more of the following features. The method further including: when the presence of an animal is detected in the area beneath the vehicle, warning, via the processor, the animal to vacate the area beneath the vehicle. The method where the step of warning the animal includes activating, via the processor, a horn system to generate a honk sound to scare the animal such that the animal will vacate the area beneath the vehicle. The method where the step of warning the animal includes activating, via the processor, an ultrasonic repelling device to produce ultrasonic sound waves configured to force the animal away from the area beneath the vehicle. The method where the step of warning the animal includes activating, via the processor, a compressed air gun to release a directed stream of pressurized air configured to force the animal away from the area beneath the vehicle. The method where notifying the vehicle occupant includes exhibiting, on a display, a video feed of the area beneath the vehicle in which the presence of an animal has been detected. The method where notifying the vehicle occupant includes producing an audio alert in an interior of the vehicle. The method further including: when the presence of an animal is not detected in the area beneath the vehicle, notifying, via the processor, a vehicle occupant that an animal has not been detected in the area beneath the vehicle. The method further including: when the presence of an animal is detected in the area beneath the vehicle, applying, via the processor, a parking brake to ensure the vehicle remains stationary. The method where detecting the presence of an animal in the area beneath the vehicle occurs after a vehicle ignition is turned to an ON state. Implementations of the described techniques may include hardware, a method or process, or computer software on a computer-accessible medium.

One general aspect includes a system of animal detection and warning, the system including: a memory configured to include one or more executable instructions and a processor configured to execute the executable instructions, where the executable instructions enable the processor to carry out the following steps: detecting a presence of an animal in an area beneath a vehicle; and when the presence of an animal is detected in the area beneath the vehicle, notifying a vehicle occupant that the animal has been detected in the area beneath the vehicle. Other embodiments of this aspect include corresponding computer systems, apparatus, and computer programs recorded on one or more computer storage devices, each configured to perform the actions of the methods.

Implementations may include one or more of the following features. The system where the executable instructions enable the processor to carryout an additional step of, when the presence of an animal is detected in the area beneath the vehicle, warning the animal to vacate the area beneath the vehicle. The system where the step of warning the animal includes activating, via the processor, a horn system to generate a honk sound to scare the animal such that the animal will vacate the area beneath the vehicle. The system where the step of warning the animal includes activating, via the processor, an ultrasonic repelling device to produce ultrasonic sound waves configured to force the animal away from the area beneath the vehicle. The system where the step of warning the animal includes activating, via the processor, a compressed air gun to release a directed stream of pressurized air configured to force the animal away from the area beneath the vehicle. The system where notifying the vehicle occupant includes exhibiting, on a display, a video feed of the area beneath the vehicle in which the presence of an animal has been detected. The system where the executable instructions enable the processor to carryout an additional step of, when the presence of an animal is detected in the area beneath the vehicle, applying, via the processor, a parking brake to ensure the vehicle remains stationary. The system where the executable instructions enable the processor to carryout an additional step of, when the presence of an animal is not detected in the area beneath the vehicle, notifying, via the processor, a vehicle occupant that an animal has not been detected in the area beneath the vehicle. The system where detecting the presence of an animal in the area beneath the vehicle occurs after a vehicle ignition is turned to an ON state. Implementations of the described techniques may include hardware, a method or process, or computer software on a computer-accessible medium.

One general aspect includes a non-transitory and machine-readable medium having stored thereon executable instructions adapted for animal detection and warning, which when provided to a processor and executed thereby, causes the processor to carry out the following steps: detecting a presence of an animal in an area beneath a vehicle; and when the presence of an animal is detected in the area beneath the vehicle, warning the animal to vacate the area beneath the vehicle. Other embodiments of this aspect include corresponding computer systems, apparatus, and computer programs recorded on one or more computer storage devices, each configured to perform the actions of the methods.

The above features and advantages and other features and advantages of the present teachings are readily apparent from the following detailed description for carrying out the teachings when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a block diagram depicting an exemplary embodiment of an electronics system capable of utilizing the system and method disclosed herein;

FIG. 2 is an exemplary flow chart for the utilization of exemplary system and method aspects disclosed herein; and

FIG. 3 is an illustrative aspect of the process flow of FIG. 2.

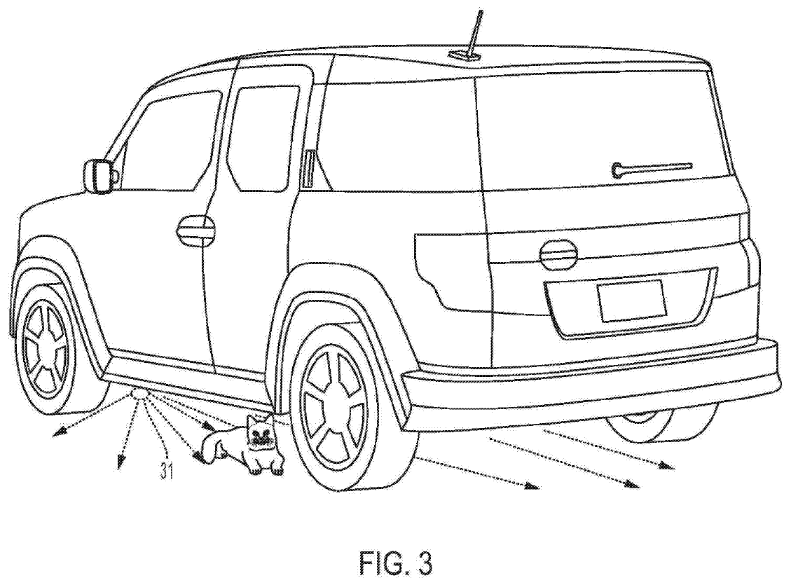

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

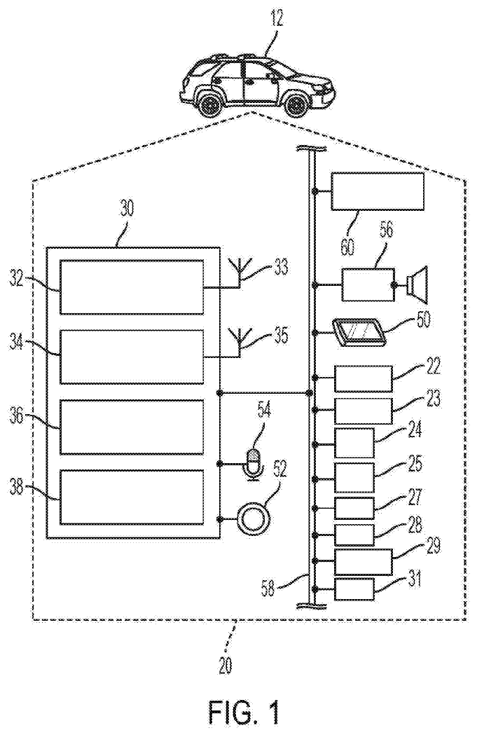

With reference to FIG. 1, vehicle 12 is depicted in the illustrated embodiment as a sports utility vehicle (SUV), but it should be appreciated that any other vehicle including motorcycles, trucks, passenger sedan, recreational vehicles (RVs), marine vessels, aircraft including unmanned aerial vehicles (UAVs), etc., can also be used. In certain embodiments, vehicle 12 may include a power train system with multiple generally known torque-generating devices including, for example, an engine. The engine may be an internal combustion engine that uses one or more cylinders to combust fuel, such as gasoline, in order to propel vehicle 12. The power train system may alternatively include numerous electric motors or traction motors that convert electrical energy into mechanical energy for propulsion of vehicle 12.

Some of the vehicle electronics 20 are shown generally, in FIG. 1 and includes a global navigation satellite system (GNSS) receiver 22, a body control module or unit (BCM) 24, and other vehicle system modules (VSMs) 28, a telematics unit 30, an undercarriage sensor 29, ultrasonic repelling device 31, vehicle-user interfaces 50-56, and onboard computer 60. Some or all of the different vehicle electronics may be connected for communication with each other via one or more communication busses, such as communications bus 58. The communications bus 58 provides the vehicle electronics with network connections using one or more network protocols and can use a serial data communication architecture. Examples of suitable network connections include a controller area network (CAN), a media oriented system transfer (MOST), a local interconnection network (LIN), a local area network (LAN), and other appropriate connections such as Ethernet or others that conform with known ISO, SAE, and IEEE standards and specifications, to name but a few. In other embodiments, a wireless communications network that uses short-range wireless communications (SRWC) to communicate with one or more VSMs of the vehicle can be used. In one embodiment, the vehicle 12 can use a combination of a hardwired communications bus 58 and SRWCs. The SRWCs can be carried out using the telematics unit 30, for example.

The vehicle 12 can include numerous vehicle system modules (VSMs) as part of vehicle electronics 20, such as the GNSS receiver 22, BCM 24, telematics unit 30 (vehicle communications system), vehicle-user interfaces 50-56, and onboard computer 60, as will be described in detail below. The vehicle 12 can also include other VSMs 28 in the form of electronic hardware components that are located throughout the vehicle and, which may receive input from one or more sensors and use the sensed input to perform diagnostic, monitoring, control, reporting, and/or other functions. Each of the VSMs 28 is hardwire connected by communications bus 58 to the other VSMs including the telematics unit 30. Moreover, each of the VSMs can include and/or be communicatively coupled to suitable hardware that enables intra-vehicle communications to be carried out over the communications bus 58; such hardware can include, for example, bus interface connectors and/or modems. One or more VSMs 28 may periodically or occasionally have their software or firmware updated and, in some embodiments, such vehicle updates may be over the air (OTA) updates that are received from a remote computer or facility via a land network (not shown) and telematics unit 30. As is appreciated by those skilled in the art, the above-mentioned VSMs are only examples of some of the modules that may be used in vehicle 12, as numerous others are also possible. It should also be appreciated that these VSMs can otherwise be known as electronic control units, or ECUs.

Global navigation satellite system (GNSS) receiver 22 receives radio signals from a constellation of GNSS satellites (not shown). The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites (not shown). And, in another example, GNSS receiver 22 can be a BDS receiver that receives a plurality of GNSS (or BDS) signals from a constellation of GNSS (or BDS) satellites. The GNSS received can determine a current vehicle location based on reception of a plurality of GNSS signals from the constellation of GNSS satellites. The vehicle location information can then be communicated to the telematics unit 30, or other VSMs, such as the onboard computer 60. In one embodiment (as shown in FIG. 1), the wireless communications module 30 and/or a telematics unit can be integrated with the GNSS receiver 22 so that, for example, the GNSS receiver 22 and the telematics unit 30 (or the wireless communications device) are directly connected to one another as opposed to being connected via communications bus 58. In other embodiments, the GNSS receiver 22 is a separate, standalone module or there may be a GNSS receiver 22 integrated into the telematics unit 30 in addition to a separate, standalone GNSS receiver connected to telematics unit 30 via communications bus 58.

Body control module (BCM) 24 can be used to control various VSMs 28 of the vehicle, as well as obtain information concerning the VSMs, including their present state or status, as well as sensor information. The BCM 24 is shown in the exemplary embodiment of FIG. 1 as being electrically coupled to the communication bus 58. In some embodiments, the BCM 24 may be integrated with or part of a center stack module (CSM) and/or integrated with telematics unit 30 or the onboard computer 60. Or, the BCM may be a separate device that is connected to other VSMs via bus 58. The BCM 24 can include a processor and/or memory, which can be similar to processor 36 and memory 38 of telematics unit 30, as discussed below. The BCM 24 may communicate with wireless device 30 and/or one or more vehicle system modules, such as an engine control module (ECM), audio system 56, or other VSMs 28; in some embodiments, the BCM 24 can communicate with these modules via the communications bus 58. Software stored in the memory and executable by the processor enables the BCM to direct one or more vehicle functions or operations including, for example, controlling central locking, controlling an electronic parking brake, power sun/moon roof, the vehicle's head lamps, activating a water gun 23, activating a compressed air gun 25, activating the horn system 27, air conditioning operations, power mirrors, controlling the vehicle primary mover (e.g., engine, primary propulsion system), and/or controlling various other vehicle system modules (VSMs). In one embodiment, the BCM 24 can be used (at least in part) to cause the horn system 27 to generate a honk sound that can warn other people and animals of the vehicle's approach, activation, presence, or to call attention to some hazard.

The water gun 23 can be mounted at some location on the undercarriage of vehicle 12 (e.g., the front and/or rear axle, muffler, exhaust, front mount, etc.). Water gun 23 is designed to shoot a stream of pressurized water at some location under the vehicle 12. For example, the water gun 23 can be used to spray pressurized water at an animal resting/hiding underneath vehicle 12, to startle and force the animal to evacuate the area underneath the vehicle 12. The compressed air gun 25 can be mounted at some location on the undercarriage of vehicle 12. Air gun 25 can also release a directed stream of pressurized air at some location under the vehicle 12. For example, similar to the water gun 23, the air gun 25 can be used to spray pressurized air at an animal resting underneath vehicle 12, to startle and force the animal to evacuate the area underneath the vehicle 12.

Telematics unit 30 is capable of communicating data via SRWC through use of SRWC circuit 32 and/or via cellular network communications through use of a cellular chipset 34, as depicted in the illustrated embodiment. The telematics unit 30 can provide an interface between various VSMs of the vehicle 12 and one or more devices external to the vehicle 12, such as one or more networks or systems at a remote call center (e.g., ON-STAR by GM). This enables the vehicle to communicate data or information with remote systems at a remote call center.

In at least one embodiment, the telematics unit 30 can also function as a central vehicle computer that can be used to carry out various vehicle tasks. In such embodiments, the telematics unit 30 can be integrated with the onboard computer 60 such that the onboard computer 60 and the telematics unit 30 are a single module. Or, the telematics unit 30 can be a separate central computer for the vehicle 12 in addition to the onboard computer 60. Also, the wireless communications device can be incorporated with or a part of other VSMs, such as a center stack module (CSM), body control module (BCM) 24, an infotainment module, a head unit, a telematics unit, and/or a gateway module. In some embodiments, the telematics unit 30 is a standalone module, and can be implemented as an OEM-installed (embedded) or aftermarket device that is installed in the vehicle.

In the illustrated embodiment, telematics unit 30 includes, the SRWC circuit 32, the cellular chipset 34, a processor 36, memory 38, SRWC antenna 33, and antenna 35. The telematics unit 30 can be configured to communicate wirelessly according to one or more SRWC protocols such as any of the Wi-Fi™, WiMAX™, Wi-Fi™ Direct, other IEEE 802.11 protocols, ZigBee™ Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. And, in some embodiments, the telematics unit 30 can be configured to communicate using IEEE 802.11p such that the vehicle can carry out vehicle-to-vehicle (V2V) communications, or vehicle-to-infrastructure (V2I) communications with infrastructure systems or devices, such as at a remote call center. And, in other embodiments, other protocols can be used for V2V or V2I communications.

The SRWC circuitry 32 enables the telematics unit 30 to transmit and receive SRWC signals, such as BLE signals. The SRWC circuit can allow the telematics unit 30 to connect to another SRWC device (e.g., a smart phone). Additionally, in some embodiments, the telematics unit 30 contains a cellular chipset 34 thereby allowing the device to communicate via one or more cellular protocols, such as those used by cellular carrier system 70, through antenna 35. In such a case, the telematics unit 30 is user equipment (UE) that can be used to in carry out cellular communications via cellular carrier system 70.

Antenna 35 is used for communications and is generally known to be located throughout vehicle 12 at one or more locations external to the telematics unit 30. Using antenna 35, telematics unit 30 may enable the vehicle 12 to be in communication with one or more local or remote networks (e.g., one or more networks at a remote call center or server) via packet-switched data communication. This packet switched data communication may be carried out through use of a non-vehicle wireless access point or cellular system that is connected to a land network via a router or modem. When used for packet-switched data communication such as TCP/IP, the communications device 30 can be configured with a static Internet Protocol (IP) address or can be set up to automatically receive an assigned IP address from another device on the network such as a router or from a network address server.

Packet-switched data communications may also be carried out via use of a cellular network that may be accessible by the telematics unit 30. Communications device 30 may, via cellular chipset 34, communicate data over wireless carrier system 70. In such a scenario, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the telematics unit 30 to provide a wide variety of services. For instance, in one embodiment, the processor 36 can execute programs or process data to carry out at least a part of the method discussed herein. Memory 38 may include any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, that stores some or all of the software needed to carry out the various external device functions discussed herein. In one embodiment, the telematics unit 30 also includes a modem for communicating information over the communications bus 58.

Vehicle electronics 20 also includes at least one undercarriage sensor 29 and at least one ultrasonic repelling device 31 (URD). The undercarriage sensor 29 can be an infrared camera (i.e., a thermographic camera/thermo imaging camera) mounted somewhere along the undercarriage of vehicle 12 (e.g., the front and/or rear axle, muffler, exhaust, front mount, etc.). Undercarriage sensor 29 forms a heat zone image using infrared radiation, in a manner that is similar to a common camera forming an image using visible light. As such, undercarriage sensor 29 can operate in wavelengths as long as 14,000 nm (14 μm) and can also provide night vision applications. The URD 31 is a low-profile animal control device that uses ultrasonic sound waves to saturate an area and force away nearby animals (e.g., cats, dogs, birds, rabbits, skunks, children, service workers, etc.).

Vehicle electronics 20 also includes a number of vehicle-user interfaces that provide vehicle occupants with a means of providing and/or receiving information, including visual display 50, pushbutton(s) 52, microphone 54, and audio system 56. As used herein, the term “vehicle-user interface” broadly includes any suitable form of electronic device, including both hardware and software components, which is located on the vehicle and enables a vehicle user to communicate with or through a component of the vehicle. The pushbutton(s) 52 allow manual user input into the communications device 30 to provide other data, response, and/or control input. Audio system 56 provides audio output to a vehicle occupant and can be a dedicated, stand-alone system or part of the primary vehicle audio system. According to one embodiment, audio system 56 is operatively coupled to both vehicle bus 58 and an entertainment bus (not shown) and can provide AM, FM and satellite radio, CD, DVD, and other multimedia functionality. This functionality can be provided in conjunction with or independent of an infotainment module. Microphone 54 provides audio input to the telematics unit 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 50 is preferably a graphics display and can be used to provide a multitude of input and output functions. Display 50 can be a touch screen on the instrument panel, a heads-up display reflected off of the windshield, a video projector that projects images onto the windshield from the vehicle cabin ceiling, or some other display. For example, display 50 can be the touch screen of the vehicle's infotainment module at the center console of the vehicle's interior. Various other vehicle-user interfaces can also be utilized, as the interfaces of FIG. 1 are only an example of one particular implementation.

### METHOD

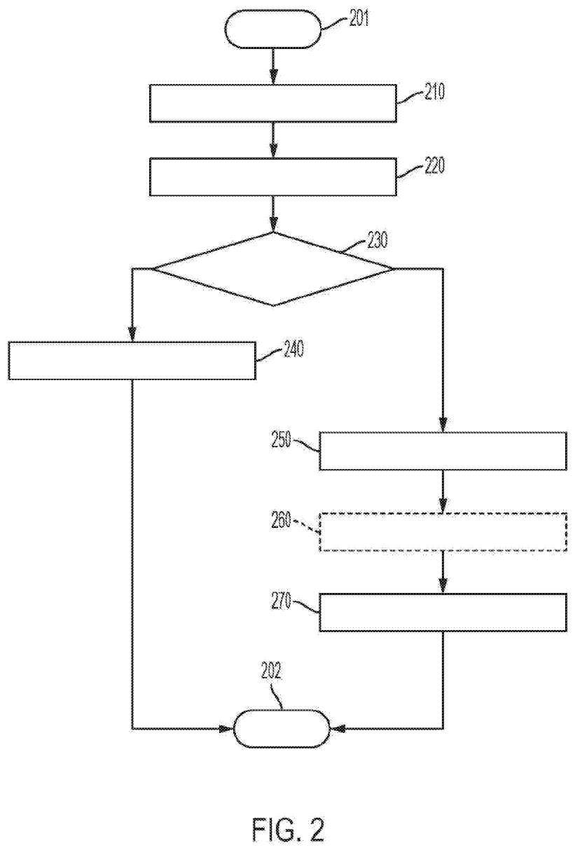

Turning now to FIG. 2, there is shown an embodiment of a method 200 to detect the presence of an animal underneath vehicle 12 and can subsequently warn the animal to vacate the area under the vehicle 12. One or more aspects of detection and warning method 200 may be carried out by telematics unit 30. For example, in order to carry out the one or more aspects of method 200, memory 38 includes executable instructions stored thereon and processor 36 executes these executable instructions. One or more ancillary aspects of method 200 may also be completed by one or more vehicle devices such as, for example, BCM 24, the water gun 23, compressed air gun 25, horn system 27, undercarriage sensor 29, ultrasonic repelling device 31, and display 50.

Method 200 begins at 201 in which vehicle 12 is parked and the ignition is in the OFF state (i.e., the vehicle is turned off). In step 210, a vehicle occupant arrives at vehicle 12 and gets into the vehicle's interior cabin. In addition, in this step, the vehicle occupant will turn the start the vehicle by turning the ignition to an ON state (i.e., to activate the vehicle's engine and other vehicle systems). In step 220, processor 36 will activate the undercarriage sensor 29 to capture one or more thermographic images (heat zone images) of the area beneath the vehicle's undercarriage. As such, if an animal is hiding beneath vehicle 12 (e.g., a cat, dog, bird, badger, rabbit, wolverine, skunk, children, auto mechanic, etc.), the animal's body heat will show up in these one or more images as a heat zone and the surrounding environment will show up as cool spots in the images.

In step 230, processor 36 will analyze the one or more thermographic images to detect any substantial heat zones. Processor 36 may also implement one or more known object recognition techniques to recognize the heat zones as being in the shape of an animal. As follows, if the processor 38 detects a heat zone large enough to be an animal, processor 38 may implement the object recognition techniques to ensure the heat zone is in fact an animal and not some other heat emitting object (e.g., a donut fresh out of the oven that has accidentally been dropped and has rolled under the vehicle). As such, when a substantial heat zone is detected and when that heat zone is found to be in the shape of an animal, it will be assumed that an animal is detected to be present in the area beneath vehicle 12. Moreover, when an animal is detected under the vehicle 12, method 200 will move to step 250; otherwise, method 200 will move to step 240 when a warm-blooded animal is not detected under the vehicle 12.

In step 240, processor 38 will notify the vehicle occupant that an animal was not detected under the vehicle 12. For example, a pre-recorded sound bite can be announced through the audio system 56. The sound bite may also state “THE VEHICLE DID NOT DETECT ANY ANIMALS HIDING UNDER THE VEHICLE”, or the like. Alternatively, the notification may be a live video feed taken by undercarriage sensor 29, which is exhibited on display 50. As follows, the video feed would be of the thermographic images. Alternatively, the notification may be a text message exhibited on one of the infotainment user interfaces shown on display 50. The text message may also state “NO ANIMALS HAVE BEEN DETECTED BENEATH THE VEHICLE”, or the like. After step 240, method 200 will move to completion 202.

In step 250, processor 38 will notify the vehicle occupant that the presence of an animal has been detected under the vehicle 12. For example, an audio alert can be made through the audio system 56 (e.g., a ding, chime, or sound bite). When the audio alert is a sound bite, the alert may also state “AN ANIMAL HAS BEEN DETECTED UNDER THE VEHICLE”, or the like. Alternatively, the notification may be a live video feed taken by undercarriage sensor 29, which is exhibited on display 50. As follows, the video feed would be of the thermographic images of the area in which the animal's presence has been detected, which will allow the vehicle occupant to see the location of the animal and verify that an animal is actually hiding under the vehicle at that location. Alternatively, the notification may be a text message exhibited on one of the infotainment user interfaces shown on display 50. The text message may also state “WARNING: THERE MAY BE AN ANIMAL BENEATH THE VEHICLE”, or the like.

In optional step 260, processor 38 will collaborate with BCM 24 to activate the vehicle's electronic power brake. This will ensure the vehicle remains stationary and the vehicle occupant will not accidentally harm the hiding animal with vehicle 12 (e.g., by running the animal over). This will also provide another way of notifying the vehicle occupant that the presence of an animal has been detected under the vehicle 12, just in case they did not happen to fully appreciate the other vehicle notification (discussed in step 250). Moreover, in this step, the vehicle occupant will have the ability to release the electronic parking brake (i.e., manually overriding the parking brake). This may allow the vehicle occupant to move their vehicle in certain instances (for example, when the presence of an animal under the vehicle has been falsely detected).

In step 270, processor 38 will collaborate with BCM 24 to cause the vehicle 12 to warn the hiding animal to vacate the area under vehicle 12. This warning can come in one or more forms. For example, in one embodiment, the warning can be an activation of the horn system to generate a loud honk sound designed to scare the hiding animal and make them feel threatened. After the animal is scared and feeling threatened they will likely vacate the area beneath the vehicle 12 and go on to seek shelter somewhere else where they will feel safe. Alternatively, in one embodiment, the warning can be the activation of the URD 31 to produce the ultrasonic sound waves to scare the hiding animal and make them feel threatened. Similar to the honk produced by the horn system, these sound waves will likely cause the scared and threatened animal to vacate the area beneath the vehicle 12 and go on to seek shelter somewhere they will feel safe. It should be understood that the URD 31 operates in a manner that is similar to the horn system, however, the sound produced by URD 31 cannot be heard by the vehicle occupant or any other vehicle passengers or human pedestrians near the vehicle 12. It should also be understood that the sound waves from the URD 31 can be directed under the vehicle 12 more so than the sound produced by the horn system.

The warning can also produce physical contact with the animal. For example, in one embodiment, the warning can be the activation of the water gun 23 to spray pressurized water at the hiding animal. As such, processor 38/BCM 24 can cause the water gun 23 to pivot under the vehicle 12 such that the barrel of the water gun 23 is pointed at some part of the animal's body. Moreover, once the pressurized water is released, it will collide with the animal to scare and threaten it and make it want to vacate the area and go on to seek shelter somewhere the animal will feel safe. Moreover, the noises associated with the pivoting of the barrel of water gun 23 and the noises associated with the operation of the water tank and pressurizing device (installed somewhere on the vehicle) may also sufficiently scare and threaten the animal and make them want to vacate the area. In another embodiment, the warning can be the activation of the compressed air gun 25 to release a stream of pressurized air directed at the hiding animal. As such, processor 38/BCM 24 can cause the air gun 25 to pivot under the vehicle such that the barrel of the air gun is pointed at some part of the animal's body. Moreover, once the pressurized air has been released, it will collide with the animal to scare and threaten it and make it want to vacate the area and go on to seek shelter somewhere the animal will feel safe. Moreover, the noises associated with the pivoting of the barrel of air gun 25, the noises from the operation of the pressurizing device (installed somewhere on the vehicle), and the noises from the pressurized air being released may also sufficiently scare and threaten the animal and make them want to vacate the area. It should be understood that more than one type of warning can be used in combination to warn the animal (e.g., using the URD 31 in combination with the air gun 25). After step 270, method 200 will move to completion 202.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for” in the claim.

What is claimed is:

1. A method of animal detection and warning, the method including:
detecting, via a processor, a presence of an animal in an area beneath a vehicle; and
when the presence of an animal is detected in the area beneath the vehicle, notifying, via the processor, a vehicle occupant that the presence of an animal has been detected in the area beneath the vehicle.

2. The method of claim 1, further comprising:
when the presence of an animal is detected in the area beneath the vehicle, warning, via the processor, the animal to vacate the area beneath the vehicle.

3. The method of claim 2, wherein the step of warning the animal comprises activating, via the processor, a horn system to generate a honk sound to scare the animal such that the animal will vacate the area beneath the vehicle.

4. The method of claim 2, wherein the step of warning the animal comprises activating, via the processor, an ultrasonic repelling device to produce ultrasonic sound waves configured to force the animal away from the area beneath the vehicle.

5. The method of claim 2, wherein the step of warning the animal comprises activating, via the processor, a compressed air gun to release a directed stream of pressurized air configured to force the animal away from the area beneath the vehicle.

6. The method of claim 2, wherein notifying the vehicle occupant comprises exhibiting, on a display, a video feed of the area beneath the vehicle in which the presence of an animal has been detected.

7. The method of claim 1, wherein notifying the vehicle occupant comprises producing an audio alert in an interior of the vehicle.

8. The method of claim 1, further comprising:
when the presence of an animal is not detected in the area beneath the vehicle, notifying, via the processor, a vehicle occupant that an animal has not been detected in the area beneath the vehicle.

9. The method of claim 1, further comprising:
when the presence of an animal is detected in the area beneath the vehicle, applying, via the processor, a parking brake to ensure the vehicle remains stationary.

10. The method of claim 1, wherein detecting the presence of an animal in the area beneath the vehicle occurs after a vehicle ignition is turned to an ON state.

11. A system of animal detection and warning, the system comprising:
a memory configured to comprise one or more executable instructions and a processor configured to execute the executable instructions, wherein the executable instructions enable the processor to carry out the following steps:
detecting a presence of an animal in an area beneath a vehicle; and
when the presence of an animal is detected in the area beneath the vehicle, notifying a vehicle occupant that the animal has been detected in the area beneath the vehicle.

12. The system of claim 11, wherein the executable instructions enable the processor to carryout an additional step of, when the presence of an animal is detected in the area beneath the vehicle, warning the animal to vacate the area beneath the vehicle.

13. The system of claim 12, wherein the step of warning the animal comprises activating, via the processor, a horn system to generate a honk sound to scare the animal such that the animal will vacate the area beneath the vehicle.

14. The system of claim 12, wherein the step of warning the animal comprises activating, via the processor, an ultrasonic repelling device to produce ultrasonic sound waves configured to force the animal away from the area beneath the vehicle.

15. The system of claim 12, wherein the step of warning the animal comprises activating, via the processor, a compressed air gun to release a directed stream of pressurized air configured to force the animal away from the area beneath the vehicle.

16. The system of claim 11, wherein notifying the vehicle occupant comprises exhibiting, on a display, a video feed of the area beneath the vehicle in which the presence of an animal has been detected.

17. The system of claim 11, wherein the executable instructions enable the processor to carryout an additional step of, when the presence of an animal is detected in the area beneath the vehicle, applying, via the processor, a parking brake to ensure the vehicle remains stationary.

18. The system of claim 11, wherein the executable instructions enable the processor to carryout an additional step of, when the presence of an animal is not detected in the area beneath the vehicle, notifying, via the processor, a vehicle occupant that an animal has not been detected in the area beneath the vehicle.

19. The system of claim 11, wherein detecting the presence of an animal in the area beneath the vehicle occurs after a vehicle ignition is turned to an ON state.

20. A non-transitory and machine-readable medium having stored thereon executable instructions adapted for animal detection and warning, which when provided to a processor and executed thereby, causes the processor to carry out the following steps:
detecting a presence of an animal in an area beneath a vehicle; and
when the presence of an animal is detected in the area beneath the vehicle, warning the animal to vacate the area beneath the vehicle.
